(19) United States
(12) Patent Application Publication
(10) Pub. No.: US 2010/0240840 A1
(43) Pub. Date: Sep. 23, 2010

(54) Resin Composition and multilayer optical member using the same

(76) Inventors: Mariko Toyama, Chiba (JP); Yasushi Sugimoto, Ibaraki (JP); Akihiro Yoshida, Ibaraki (JP); Shingo Kobayashi, Ibaraki (JP); Keishi Hamada, Ibaraki (JP); Hidekazu Kondou, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/308,407

(22) PCT Filed: Jun. 13, 2007
(86) PCT No.: PCT/JP2007/061900

§ 371 Date: Dec. 15, 2008

(30) Foreign Application Priority Data
Jun. 14, 2006 (JP) 2006-165035

(51) Int. Cl. C08F 290/06

(52) U.S. Cl. 525/450

(57) ABSTRACT

The object of the invention is to provide a resin composition suitably used for optical members, which is excellent in fine pattern transferability, releasability from a mold, and adhesion to a supporting base, as well as a multilayer optical member obtained by using the resin composition. To achieve this object, there is provided a resin composition comprising a urethane oligomer (A), a bifunctional monomer (B) and a polymerization initiator (C), wherein the urethane oligomer (A) is obtained by blending a diisocyanate compound having two isocyanate groups in a molecule, a hydroxylated methylene glycol compound and a caprolactone-modified (meth)acrylate compound such that the equivalent ratio between the isocyanate groups and the hydroxyl groups in the general formulae (I) and (II) (NCO/OH) is 0.8 to 1.2, as well as a multilayer optical member obtained by using the resin composition.

### TECHNICAL FIELD

The present invention relates to a resin composition excellent in fine pattern transferability and suitable for use in an optical member, and an optical member using the same.

### BACKGROUND ART

As the luminance enhancement film of a backlight for a cell phone, a liquid crystal or the like, a prism sheet as shown in FIG. 1 has been conventionally used (see, for example, Patent Document 1). There are cases where only one prism sheet is used as shown in FIG. 1 and two prism sheets are used as shown in FIG. 2. When two sheets are used, two prism sheets are superimposed on each other at a certain angle thereby increasing luminance (see, for example, Patent Document 2). In FIGS. 1 and 2, numeral 1 is a prism sheet, 2 is LED, 3 is a light guide, 4 is a reflection film, 5 is a diffusion film, 6 is an upward longitudinal prism sheet, and 7 is a downward horizontal prism sheet.

### Patent Document 1: Japanese Patent No. 2739730

### Patent Document 2: Japanese Examined Patent Publication (JP-B) No. 1-37801

### DISCLOSURE OF INVENTION

However, the prism sheet bends an outgoing ray geometric-optically, so that when one prism sheet is used in a luminance enhancement film, its concavo-convex height is increased, resulting in making the resulting sheet thick and hardly thin. Each prism functions in bending a ray, so that when prism defects or foreign substances occur, the ray passing through the prism becomes an extraordinary ray to cause abnormal displays such as luminescent spots. Further, there is a problem that the handling of the prism sheet is difficult when assembled because of its rigidity. On the other hand, when two prism sheets are used in a luminance enhancement film, there is a problem that the cost is raised and the thickness is increased. Accordingly, there has been demand for a luminance enhancement film that solves these problems all at once.

To solve the problem, the present inventors contemplated development of a diffractive luminance enhancement film. The diffractive luminance enhancement film is an optical film provided with a fine pattern of repeating angular protrusions by which a ray outgoing from a light source is bent to about 60° with a light guide and the ray is further bent toward the user (see, for example, numeral 8 in FIG. 3). Further, high transparency and thinning of the luminance enhancement film can be simultaneously attained by using a hologram optical element utilizing diffraction/interference phenomena based on the wave property of light.

Unlike the conventional prism sheet utilizing geometric-optics, the diffractive luminance enhancement film has a triangular pitch that should be about 1/10 or less in width and height relative to that of the prism sheet, as shown in FIG. 4. While the conventional prism sheet has a triangular pitch width (cycle length) of 50 μm and a vertical angle of 63°, the diffractive luminance enhancement film has a triangular pitch width of 5 μm and a vertical angle of 45° (in FIG. 4, numeral 11 is a supporting base film). However, the transfer of such fine pattern by release from a mold is very difficult. Therefore, the material of the diffractive luminance enhancement film is required to have not only characteristics required of the known prism sheet but also fine pattern transferability.

Accordingly, the object of the present invention is to provide a resin composition excellent in fine pattern transferability, releasability from a mold and adhesion to a supporting base, a diffractive luminance enhancement film using the same, and optical members such as a multilayer optical member.

The present inventors made extensive study, and as a result, they found that the problem can be solved by selecting a specific urethane oligomer and a specific bifunctional monomer, and the present invention was thereby completed.

That is, the present invention is characterized by subjects described in the following (1) to (6):

(1) A resin composition including:

a urethane oligomer (A) obtained by blending:

a diisocyanate compound having two isocyanate groups in a molecule,

a hydroxylated methylene glycol compound represented by the following general formula (I):

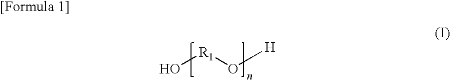

wherein R₁ is a linear or branched hydrocarbon group having 1 to 10 carbon atoms, and n is an integer of 1 to 20, and

a caprolactone-modified (meth)acrylate compound represented by the following general formula (II):

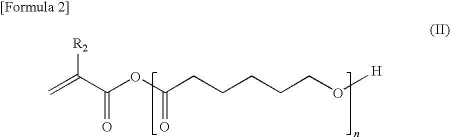

wherein R₂ is a hydrogen atom or a methyl group, and n is an integer of 1 to 10, such that the equivalent ratio between the isocyanate groups and the hydroxyl groups in the general formulae (I) and (II) (NCO/OH) is 0.8 to 1.2,

a bifunctional monomer (B), and

a polymerization initiator (C).

(2) The resin composition according to the above-mentioned (1), wherein the weight-average molecular weight (Mw) of the urethane oligomer (A) is 2,000 to 20,000.
(3) The photocurable resin composition according to the above-mentioned (1) or (2), wherein the compounding ratio of the urethane oligomer (A) to the bifunctional monomer (B) is in the range of from 1:9 to 9:1 by weight.
(4) The resin composition according to any of the above-mentioned (1) to (3), wherein the polymerization initiator (C) is contained in an amount of 0.01 to 5 parts by weight based on 100 parts by weight of the urethane oligomer (A) and the bifunctional monomer (B) in total.
(5) The resin composition according to any of the above-mentioned (1) to (4), wherein the bifunctional monomer (B) is one member or more selected from the group consisting of tetramethylene glycol diacrylate, dimethylol-tricyclodecane diacrylate, 1,9-nonanediol diacrylate, 1,6-hexanediol diacrylate, neopentyl glycol diacrylate, 2-butyl-2-ethyl-1,3-propanediol diacrylate, bisphenol A propylene oxide-added diacrylate, and caprolactone-modified tricyclodecane dimethanol diacrylate.
(6) A multilayer optical member obtained by using the resin composition of any of the above-mentioned (1) to (5).

According to the present invention described above, there can be provided a resin composition excellent in fine pattern transferability, releasability from a mold and adhesion to a supporting base, a diffractive luminance enhancement film using the same, and optical members such as a multilayer optical member. The resin composition of the present invention is also excellent in optical characteristics and is thus preferably used in an optical lens sheet (for example, a reflective film and the like) requiring fine pattern transferability.

This application claims priority based on prior Japanese Patent Application No. 2006-165035 filed by the same applicant on Jun. 14, 2006, the disclosure of which is expressly incorporated herein by reference in its entirety.

### BRIEF DESCRIPTION OF THE DRAWINGS

FIG. 1 is a constitution diagram of a backlight using one prism sheet.

FIG. 2 is a constitution diagram of a backlight using two prism sheets.

FIG. 3 is a constitution diagram of a backlight using a diffractive luminance enhancement film.

FIG. 4 is a comparative diagram of an angular fine pattern in a diffractive luminance enhancement film and a prism sheet.

FIG. 5 is a view showing one embodiment of a method for manufacturing a diffractive luminance enhancement film.

FIG. 6 is a sectional view showing one example of the shape of an angular repeating unit.

FIG. 7 is a view showing one example of a reflective film.

FIG. 8 is a view showing one embodiment of a method for manufacturing a spacer for liquid crystal display device.

FIG. 9 is a view showing one embodiment of a method for manufacturing a nanoimprint.

FIG. 10 is a view showing one example of an oriented film for liquid crystal display device.

FIG. 11 is a sectional view showing one embodiment of a multilayer optical member.

FIG. 12 is a photomacrograph of a fine pattern formed on a wide view film prepared in Example 9.

FIG. 13 is a photograph showing the difference in vision in an oblique direction between the place of a liquid crystal display on which a wide view film prepared in Example 9 is mounted and the place of the liquid crystal display on which it is not mounted.

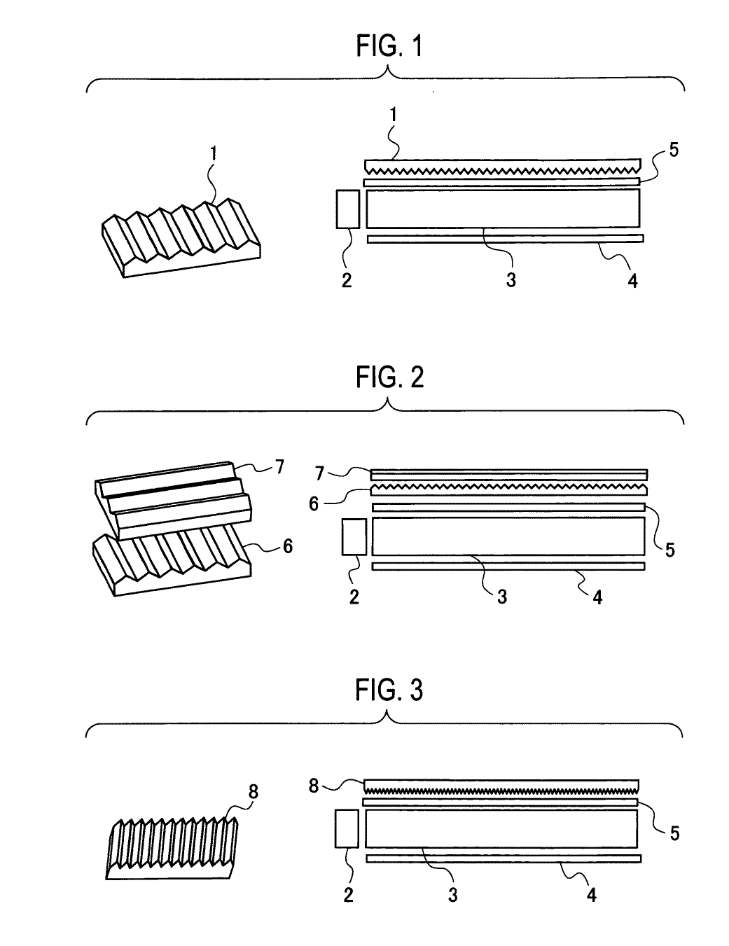

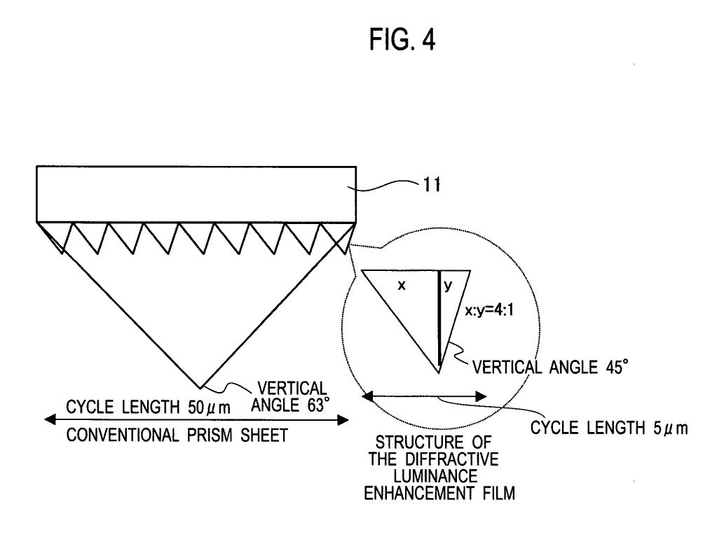

### BEST MODE FOR CARRYING OUT THE INVENTION

The resin composition of the present invention is characterized by including a urethane oligomer (A), a bifunctional monomer (B) and a polymerization initiator (C) as essential components. Hereinafter, the respective components are described in detail.

The urethane oligomer (A) is obtained preferably by blending:

a diisocyanate compound having two isocyanate groups in a molecule,

a hydroxylated methylene glycol compound represented by the following general formula (I):

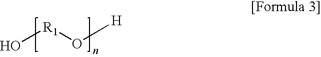

wherein R₁ is a linear or branched hydrocarbon group having 1 to 10 carbon atoms, and n is an integer of 1 to 20, and

a caprolactone-modified (meth)acrylate compound represented by the following general formula (II):

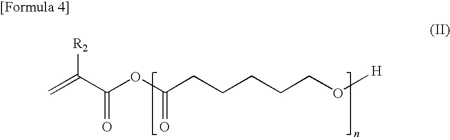

wherein R₂ is a hydrogen atom or a methyl group, and n is an integer of 1 to 10, such that the equivalent ratio between the isocyanate groups and the hydroxyl groups in the general formulae (I) and (II) (NCO/OH) is 0.8 to 1.2. The term “(meth)acrylate” as used herein refers to acrylates or methacrylates.

The diisocyanate compound having 2 isocyanate groups in a molecule includes, for example, tolylene diisocyanate, xylylene diisocyanate, diphenyl methane diisocyanate, hexamethylene diisocyanate, trimethyl hexamethylene diisocyanate, tetramethyl xylylene diisocyanate, isophorone diisocyanate, norbornane diisocyanate, hydrogenated tolylene diisocyanate, hydrogenated xylylene diisocyanate, and hydrogenated diphenyl methane diisocyanate, and these compounds may be used singly or as a mixture thereof. Among them, isophorone diisocyanate, trimethyl hexamethylene diisocyanate or tetramethyl xylene diisocyanate is preferable from the viewpoint of yellow discoloration of the resulting urethane oligomer and excellent handleability.

The hydroxylated methylene glycol compound represented by the general formula (I) above include, for example, polyethylene glycol, polypropylene glycol, polytetramethylene glycol, methyl pentanediol-modified polytetramethylene glycol, propylene glycol-modified polytetramethylene glycol, an ethylene glycol-propylene glycol block copolymer and an ethylene glycol-tetramethylene glycol copolymer, and also include polycarbonate diols having a weight-average molecular weight of 500 to 2,000 obtained by de-methanol reaction between a dimethyl carbonate compound and 1,6-hexanediol, 2-methyl-1,8-octanediol, 1,9-nonanediol, 3-methyl-1,5-pentanediol, 1,5-pentanediol or 1,4-butanediol, or a mixture thereof. In view of the fact that a diffractive luminance enhancement film having suitable flexibility can be obtained, polyethylene glycol, polypropylene glycol and polytetramethylene glycol, each of which has a weight-average molecular weight of 300 to 2,000, are preferable, and polyethylene glycol, polypropylene glycol and polytetramethylene glycol each having a weight-average molecular weight of 500 to 1,800 are more preferable.

For the purpose of regulating the weight-average molecular weight of the urethane oligomer, high-molecular-weight and low-molecular-weight hydroxylated methylene glycol compounds can be simultaneously used. For example, when a urethane oligomer is synthesized using only polytetramethylene glycol (weight-average molecular weight 850) in a certain system, the weight-average molecular weight of the resulting urethane oligomer is 10,000, but when diethylene glycol (weight-average molecular weight 106) is added in a weight ratio of 1/50 to polytetramethylene glycol (weight-average molecular weight 850), the weight-average molecular weight of the resulting urethane oligomer is reduced to 7,000. By adding a low-molecular-weight hydroxylated methylene glycol compound such as diethylene glycol, dipropylene glycol or 1,6-hexanediol in a small amount in the manner described above, the weight-average molecular weight of the resulting urethane oligomer can be reduced while the flexibility of the high-molecular-weight hydroxylated methylene glycol compound is maintained. On the other hand, the molecular weight of the urethane oligomer can be increased by adding a high-molecular-weight hydroxylated methylene glycol compound such as polyethylene glycol (weight-average molecular weight 2,000), polypropylene glycol (weight-average molecular weight 2,000) or polytetramethylene glycol (weight-average molecular weight 2,000) to a low-molecular-weight hydroxylated methylene glycol compound.

The caprolactone-modified (meth)acrylate compound represented by the general formula (II) is an unsaturated aliphatic acid hydroxyalkyl ester modified with ε-caprolactone, which has one radical-polymerizable (meth)acryl double bond added to a polycaprolactone oligomer, and examples thereof include hydroxyethyl (meth)acrylate to which 1 mole of caprolactone was added, hydroxyethyl (meth)acrylate to which 2 moles of caprolactone were added, hydroxyethyl (meth)acrylate to which 3 moles of caprolactone were added, hydroxyethyl (meth)acrylate to which 5 moles of caprolactone were added, and hydroxyethyl (meth)acrylate to which 10 moles of caprolactone were added. In view of the fact that a diffractive luminance enhancement film having suitable flexibility can be obtained, hydroxyethyl (meth)acrylate to which 2 moles of caprolactone were added or hydroxyethyl (meth)acrylate to which 3 moles of caprolactone were added is more preferable. As (meth)acrylate added to polycaprolactone, 2-hydroxypropyl (meth)acrylate, 2-hydroxybutyl (meth)acrylate can also be used.

In addition to the raw materials described above, a known polymerization inhibitor and catalyst can be added in synthesizing the urethane oligomer (A). The polymerization inhibitor may be a polymerization inhibitor known in the art and includes, for example, p-methoxyquinone, p-methoxyphenol, and p-t-butyl catechol. The catalyst may be a known catalyst used in synthesis of urethane oligomers and includes, for example, dibutyltin dilaurate, dibutyltin diacetate and triethylene diamine.

As a molecular weight regulator, a mercaptan compound, thioglycol, carbon tetrachloride, an α-methyl styrene dimer, or the like can be added as necessary in synthesis of the urethane oligomer (A).

The weight-average molecular weight (Mw) of the urethane oligomer (A) is preferably in the range of 2,000 to 20,000, more preferably in the range of 4,000 to 18,0000, still more preferably in the range of 6,000 to 16,000. When the weight-average molecular weight is lower than 2,000, sufficient flexibility tends to be hardly obtainable, while when the weight-average molecular weight is higher than 20,000, compatibility with a bifunctional monomer tends to be deteriorated. The weight-average molecular weight in the present invention is determined with a calibration curve prepared by using standard polystyrene in gel permeation chromatography (GPC). The measurement conditions are as follows:

### (Gpc Conditions)

Used instrument: Hitachi L-6000 manufactured by Hitachi, Ltd.
Columns: Gelpack GL-R420+Gelpack GL-R430+Gelpack GL-R440 (3 columns in total) manufactured by Hitachi Chemical Co., Ltd.
Eluent: tetrahydrofuran
Measurement temperature: 40° C.
Flow rate: 1.75 ml/min.
Detector: L-3300 RI manufactured by Hitachi, Ltd.

One example of a method for synthesizing the urethane oligomer (A) is as follows:

A three-neck flask is equipped with a stirrer, a thermometer, a condenser and an air inlet tube, then an air gas is introduced into the flask, a hydroxylated methylene glycol compound, a caprolactone-modified (meth)acrylate compound, a polymerization inhibitor and a catalyst are added in suitable amounts and heated to 70° C., and a diisocyanate compound is added dropwise to the mixture under stirring at 70 to 75° C., to effect the reaction. After dropwise addition, the mixture is reacted for about 5 hours and subjected to IR measurement to confirm disappearance of the isocyanate, and the reaction is finished.

The bifunctional monomer (B) used in the resin composition of the present invention is not particularly limited as long as it functions as a reactive diluent for the urethane oligomer (A), and examples thereof include bifunctional (meth)acrylates such as ethylene glycol di(meth)acrylate, diethylene glycol di(meth)acrylate, triethylene glycol di(meth)acrylate, tetraethylene glycol di(meth)acrylate, pentaethylene glycol di(meth)acrylate, hexaethylene glycol di(meth)acrylate, heptaethylene glycol di(meth)acrylate, octaethylene glycol di(meth)acrylate, nonaethylene glycol di(meth)acrylate, decaethylene glycol di(meth)acrylate, undecaethylene glycol di(meth)acrylate, dodecaethylene glycol di(meth)acrylate, tridecaethylene glycol di(meth)acrylate, tetradecaethylene glycol di(meth)acrylate, pentadecaethylene glycol di(meth)acrylate, hexadecaethylene glycol di(meth)acrylate, heptadecaethylene glycol di(meth)acrylate, octadecaethylene glycol di(meth)acrylate, nonadecaethylene glycol di(meth)acrylate, propylene glycol di(meth)acrylate, dipropylene glycol di(meth)acrylate, tripropylene glycol di(meth)acrylate, tetrapropylene glycol di(meth)acrylate, pentapropylene glycol di(meth)acrylate, hexapropylene glycol di(meth)acrylate, heptapropylene glycol di(meth)acrylate, octapropylene glycol di(meth)acrylate, nonapropylene glycol di(meth)acrylate, decapropylene glycol di(meth)acrylate, undecapropylene glycol di(meth)acrylate, dodecapropylene glycol di(meth)acrylate, tridecapropylene glycol di(meth)acrylate, tetradecapropylene glycol di(meth)acrylate, pentadecapropylene glycol di(meth)acrylate, hexadecapropylene glycol di(meth)acrylate, heptadecapropylene glycol di(meth)acrylate, octadecapropylene glycol di(meth)acrylate, nonadecapropylene glycol di(meth)acrylate, methanediol di(meth)acrylate, 1,2-ethanediol di(meth)acrylate, 1,3-butanediol di(meth)acrylate, 1,3-propanediol di(meth)acrylate, 1,4-butanediol di(meth)acrylate, 1,5-pentanediol di(meth)acrylate, 1,6-hexanediol di(meth)acrylate, 1,7-heptanediol di(meth)acrylate, 1,8-octanediol di(meth)acrylate, 1,9-nonanediol di(meth)acrylate, 1,10-decanediol di(meth)acrylate, 2-butyl-2-ethyl-1,3-propanediol di(meth)acrylate, 3-methyl-1,5-pentanediol di(meth)acrylate, neopentyl di(meth)acrylate, dimethylol tricyclodecane di(meth)acrylate, bisphenol A ethylene oxide-added di(meth)acrylate, bisphenol A propylene oxide-added di(meth)acrylate, zinc di(meth)acrylate, 2-(meth)acryloyloxyethyl acid phosphate, and caprolactone-modified tricyclodecane dimethanol di(meth)acrylate, and these compounds can be used singly or as a mixture thereof. Among them, tetramethylene glycol diacrylate, dimethylol-tricyclodecane diacrylate, 1,9-nonanediol diacrylate, 1,6-hexanediol diacrylate, neopentyl glycol diacrylate, 2-butyl-2-ethyl-1,3-propanediol diacrylate, bisphenol A propylene oxide-added diacrylate, and caprolactone-modified tricyclodecane dimethanol diacrylate are preferable in consideration of releasability from a mold, adhesion to a base film, and workability. Monofunctional monomers and trifunctional or more monomers can also be used in consideration of releasability from a mold, adhesion to a base film, and workability.

The compounding ratio of the urethane oligomer (A) to the bifunctional monomer (B) is preferably in the range of from 1:9 to 9:1 by weight, more preferably in the range of from 2:8 to 8:2, still more preferably in the range of from 3:7 to 7:3. When the compounding ratio of the component (A) to the total of the components (A) and (B) is set to 1/10 or more, the deterioration in workability caused by too low viscosity can be prevented, and the inconvenience of film cracking can be prevented or reduced. When the compounding ratio of the compound (A) is set to 9/10 or less, the deterioration in workability caused by too high viscosity can be prevented.

As the polymerization initiator (C) used in the resin composition of the present invention, a known photoinitiator and radical polymerization (heat polymerization) initiator can be used. The photoinitiator is preferably that which does not cause yellow discoloration of a cured resin by efficiently absorbing an ultraviolet ray of an industrial UV irradiation device to activate the monomers, and examples include 1-hydroxycyclohexyl phenyl ketone, 2,2-dimethoxy-1,2-diphenylethan-1-one, 2-hydroxy-methyl-1-phenyl-propan-1-one, oligo(2-hydroxy-2-methyl-1-(4-(1-methylvinyl)phenyl)propanone, a mixture of oligo(2-hydroxy-2-methyl-1-(4-(1-methylvinyl)phenyl) propanone and tripropylene glycol diacrylate, and a mixture of oxy-phenyl-acetic acid 2-(2-oxo-2-phenyl-acetoxy-ethoxy)-ethyl ester and oxy-phenyl-acetic acid 2-(2-hydroxy-ethoxy)-ethyl ester. From the problem of an offensive smell after curing, examples of the photoinitiator include oligo(2-hydroxy-2-methyl-1-(4-(1-methylvinyl)phenyl)propanone, a mixture of oligo(2-hydroxy-2-methyl-1-(4-(1-methylvinyl)phenyl) propanone and tripropylene glycol diacrylate, and a mixture of oxy-phenyl-acetic acid 2-(2-oxo-2-phenyl-acetoxy-ethoxy)-ethyl ester and oxy-phenyl-acetic acid 2-(2-hydroxy-ethoxy)-ethyl ester. The radical polymerization initiator is not particularly limited, and any polymerization initiators that can be used in ordinary radical polymerization, such as organic peroxides such as benzoyl peroxide, lauroyl peroxide, di-t-butylperoxyhexahydroterephthalate, t-butylperoxy-2-ethylhexanoate, 1,1-t-butylperoxy-3,3,5-trimethylcyclohexane and t-butylperoxyisopropylcarbonate; azo compounds such as azobisisobutyronitrile, azobis-4-methoxy-2,4-dimethylvaleronitrile, azobiscyclohexanone-1-carbonitrile, and azodibenzoyl; water-soluble catalysts such as potassium persulfate, ammonium persulfate; and redox catalysts consisting of a combination of a peroxide or persulfate and a reducing agent can be used.

The polymerization initiator (C) is contained in an amount of preferably 0.01 to 5 parts by weight, more preferably 0.1 to 3 parts by weight, based on 100 parts by weight of the urethane oligomer (A) and the bifunctional monomer (B) in total. When the amount of the polymerization initiator (C) is less than 0.01 part by weight, the polymerization reaction may not sufficiently proceed. On the other hand, addition of the polymerization initiator in an amount of more than 5 parts by weight does not bring about much improvement in its effect and is thus economically not preferable.

As a molecular weight regulator, mercaptan-based compounds, thioglycol, carbon tetrachloride, α-methyl styrene dimer can be added as necessary to the resin composition of the present invention. From the viewpoint of anti-deterioration, thermal stability, moldability and workability, antioxidants such as phenol and thioether, mold release agents such as aliphatic alcohol, fatty acid ester, phthalate ester, triglycerides, fluorochemical surfactant and higher fatty acid metal salt, a lubricant, a plasticizer, an antistatic agent, an ultraviolet absorber, a flame retardant, a heavy metal deactivator and the like may be added to the resin composition of the present invention.

The resin composition of the present invention can be used preferably as a material of diffractive luminance enhancement film. The diffractive luminance enhancement film of the present invention has, at least one side of a supporting base film, a fine pattern formed by molding and curing the resin composition of the present invention.

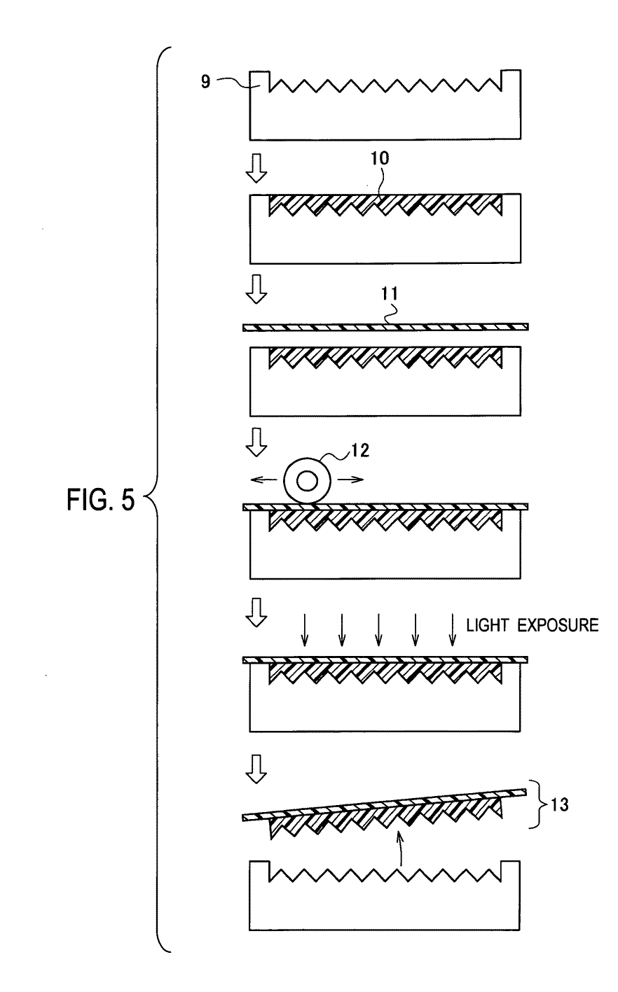

The method of manufacturing a diffractive luminance enhancement film by using the resin composition of the present invention is not particularly limited. For example, as shown in FIG. 5, a mold 9 having a desired fine pattern formed thereon is filled with the resin composition 10 of the present invention, and a light-transmissible supporting base film 11 is superimposed thereon. The resin composition is spread and flattened with a roller 12 thereon, and then cured by irradiation via the supporting base film 11 with an ultraviolet ray. After curing, the cured resin composition integrated with the supporting base film 11 can be released from the mold 9 to give a diffractive luminance enhancement film 13.

A multilayer optical member can also be produced by using the resin composition of the present invention, and its manufacturing method is not particularly limited. For example, similar to production of the diffractive luminance enhancement film described above, a mold having a desired fine pattern formed thereon is filled with the resin composition of the present invention, and a light-transmissible supporting base film is superimposed thereon. The resin composition is spread and flattened with a roller thereon, and then cured by irradiation via the supporting base film with an ultraviolet ray (first resin composition layer). After curing, the cured resin composition integrated with the supporting base film is released from the mold. Further, the resin composition of the present invention is applied onto the patterned surface of the cured resin composition, and a light-transmissible film that was subjected to release treatment is superimposed thereon. The resin composition is spread and flattened with a roller thereon, and then cured by irradiation via the film with an ultraviolet ray (second resin composition layer). After curing, a multilayer optical member can be obtained by releasing the film (see, for example, FIG. 11 wherein numeral 20 is a supporting base film, 21 is a mold-transfer layer (first resin composition layer), and 22 is an overcoat layer (second resin composition layer)). Alternatively, the resin composition that was uniformly applied onto a light-transmissible supporting base film is superimposed on the patterned surface of the cured resin composition, and they are stuck on each other with a roller or the like and thereby integrated with each other, and the resin composition is cured by irradiation via the film with an ultraviolet ray, whereby a multilayer optical member can be obtained. Another pattern can also be formed on the multilayered flattened surface.

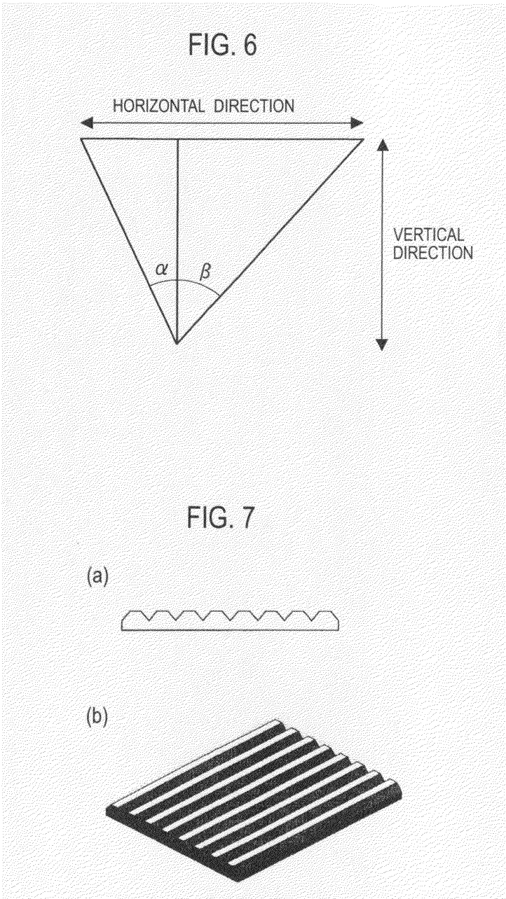

The material of the mold is not particularly limited, and examples include aluminum, nickel, copper, and alloys thereof. The fine pattern formed on the mold may be appropriately determined depending on the type and characteristics of a desired optical member and is not particularly limited. The fine pattern includes patterns of repeating units that are for example angular (triangular), concavo-convex, stair-like, trapezoidal or sinusoidal in section. The dimensions of the repeating unit are not particularly limited either and can be determined appropriately depending on the type or characteristics of a desired optical member. For example, the dimensions of the repeating unit for the diffractive luminance enhancement film are preferably 10 μm or less in both horizontal and vertical directions relative to the plane of the supporting base film, and the lower limit thereof is 3 μm or more in the horizontal direction or 2.5 μm or more in the vertical direction. FIG. 6 is a view showing the horizontal and vertical directions where the cross-sectional shape of the repeating unit is angular. The vertical angle in this figure (angle α+angle β in FIG. 6) is preferably 45′ to 60°, and in FIG. 6, it is preferable that the angle α is 20° or less, and the angle β is 25° to 40°.

The light-transmissible supporting base film is not particularly limited as long as it has light transmissibility, and examples of the supporting base film that can be used include transparent synthetic resin films such as a polyester resin film (for example, polyethylene terephthalate), an acrylic resin film, a polycarbonate resin film, a vinyl chloride resin film, a polymethacrylamide resin film, and a polyester resin film. The thickness of the supporting base film is preferably 25 to 200 μm, more preferably 50 to 150 μm. When the supporting base film is too thick, the resulting condensing film is made too heavy, while when the supporting base film is too thin, it tends to be warped upon curing. When a radical polymerization initiator is used as the polymerization initiator (C), use of a light-transmissible supporting base film is not particularly necessary, and a heat-resistant supporting base film is preferably used.

As the light source used in the ultraviolet ray irradiation, a chemical lamp, a low-pressure mercury lamp, a high-pressure mercury lamp, a carbon arc, or a xenon lamp can be used, and the irradiation atmosphere may be in the air or the like and is not particularly limited.

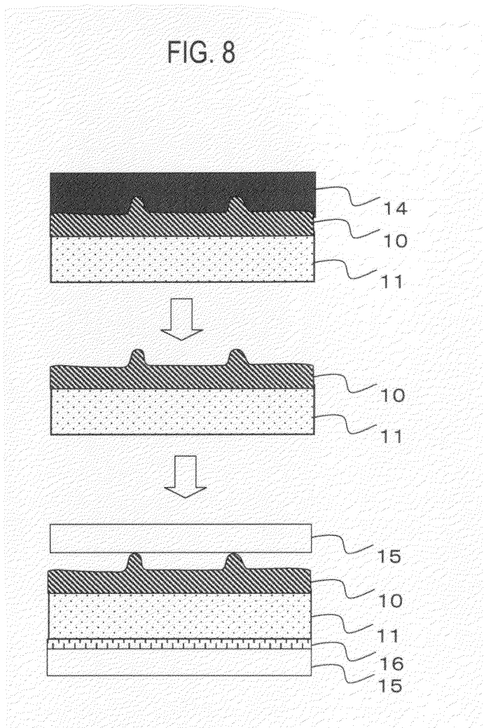

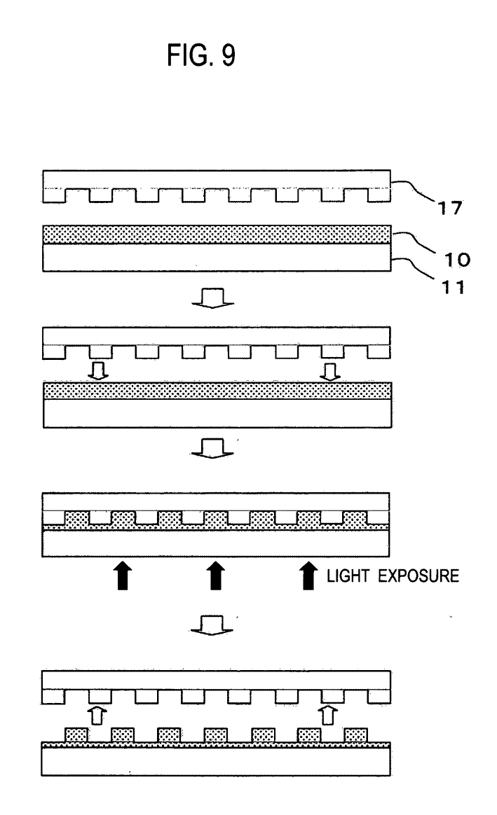

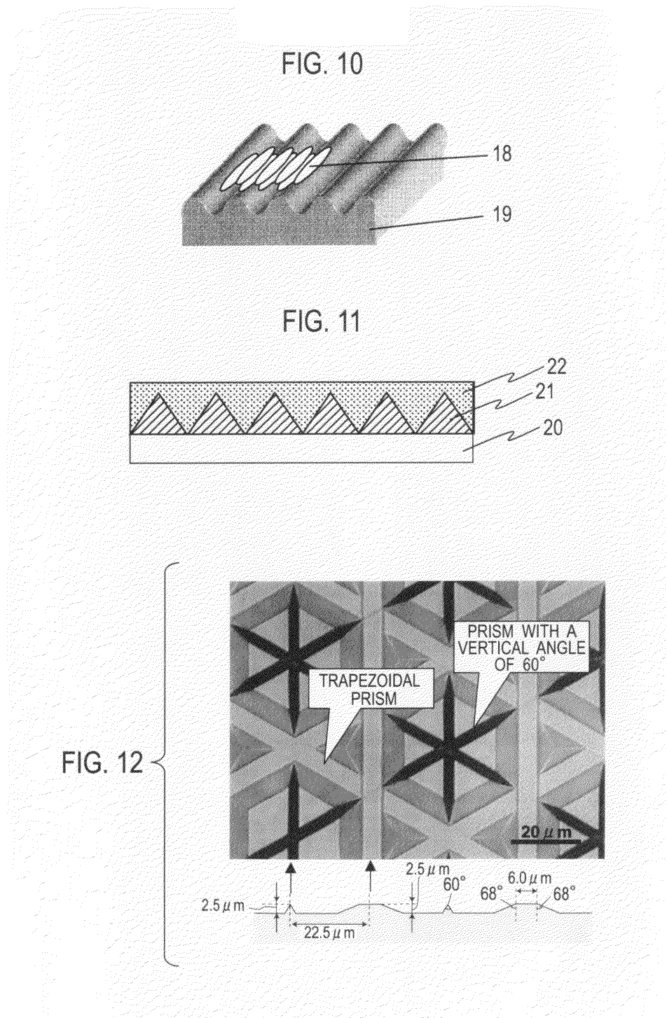

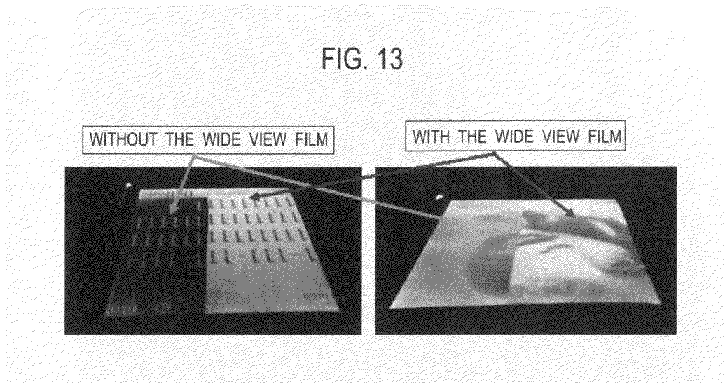

The resin composition of the present invention is excellent in fine pattern transferability, and the limit of pattern transferability is 1 nm or more in the horizontal direction and 1 nm or more in the vertical direction. Accordingly, the resin composition of the present invention can be used as a material of various optical members such as a reflective film (FIG. 7), a spacer for liquid crystal display device (FIG. 8; numeral 14 is a mold of a spacer for liquid crystal display, 15 is a glass, and 16 is an adhesive), a nanoimprint (FIG. 9; numeral 17 is a mold for a nanoimprint), an oriented film for liquid crystal display device (FIG. 10; numeral 18 is a liquid crystal molecule, and 19 is an oriented film for liquid crystal display), a waveguide cladding material, a Fresnel lens, a lenticular lens sheet, a diffuser, and a moth-eye antireflection structure. The resin composition of the present invention is also excellent in optical characteristics and can thus be used in fine parts, devices such as ink-jet optical components (microlens, optical interconnection), MEMS and the like. As described above, the resin composition of the present invention can be formed into a multilayer optical member laminated with two or more layers each consisting of the resin composition and can be used for example in a wide view film, an optical diffusion sheet, a view angle compensation film, an anti-glare antireflective film, and a reflective projection screen.

### EXAMPLES

Hereinafter, the present invention will be described in detail by reference to the Examples which however do not limit the scope of the present invention.

### <Synthesis of Urethane Oligomer>

(Urethane oligomer 1)

A 2-L three-neck flask was equipped with a stirrer, a thermometer, a condenser and an air inlet tube, then an air gas was introduced into the flask, 520.80 g of polytetramethylene glycol (trade name: PTG850SN; in formula (I), n=11, R₁═(CH₂)₄; manufactured by Hodogaya Chemical Co., Ltd.), 1.06 g of diethylene glycol, 275.20 g of an unsaturated aliphatic acid hydroxyalkyl ester modified with ε-caprolactone (trade name: FA2D; in formula (II), n=3, R₂═H; manufactured by Daicel Chemical Industries, Ltd.), 0.5 g of p-methoxyquinone as a polymerization inhibitor, and 0.3 g of dibutyltin dilaurate (trade name: L101, manufactured by Tokyo Fine Chemical Co., Ltd.) as a catalyst, then the mixture was heated to 70° C., and 222 g of isophorone diisocyanate (trade name: DESMODULE I, manufactured by Sumika Bayer Urethane Co., Ltd.) was added dropwise over 2 hours to the mixture under stirring at 70 to 75° C., to effect the reaction. After dropwise addition, the mixture was reacted for about 5 hours and subjected to IR measurement to confirm disappearance of the isocyanate, and the reaction was finished. In this manner, a urethane oligomer (UA1) having a weight-average molecule weight of 7,000 was obtained.

### (Urethane Oligomer 2)

A urethane oligomer 2 (UA2) was synthesized in the same manner as in synthesis of UA1 described above except that the polytetramethylene glycol was 0 g, the unsaturated aliphatic acid hydroxyalkyl ester modified with ε-caprolactone was 828 g, and the isophorone diisocyanate was 208 g. The weight-average molecular weight of the urethane oligomer 2 was 1,000.

### Examples 1 to 3 and Comparative Examples 1 to 7

### Preparation of Photocurable Resin Compositions

The components shown in Table 1 were mixed to prepare the photocurable resin compositions in Examples 1 to 3 and Comparative Examples 1 to 7.

### <Preparation of Diffractive Luminance Enhancement Film>

A diffractive luminance enhancement film mold (small mold; material, Ni—P; angular pitch: width 5 μm, height 5.7 μm, vertical angle 45°; lattice pattern size: length 2 cm, width 1 cm, manufactured by Toshiba Machine Co., Ltd.) was filled with each of the resin compositions obtained above, and a PET film (trade name: A4300, film thickness 75 μm, manufactured by Toyobo Co., Ltd.) serving as a supporting base film was superimposed thereon. The resin composition was spread and flattened with a roller running thereon, and then cured by light exposure. This light exposure was conducted with an integrated light exposure of 2,000 mJ/cm² with an ultrahigh pressure mercury lamp (USH-3502MA, illuminance 16 mW/cm², manufactured by Ushio, Inc.). After curing, the cured resin composition integrated with the supporting base film was released from the mold, to give a diffractive luminance enhancement film. The resin composition in Comparative Example 1 was highly viscous and thus hardly handled, thus failing to produce a diffractive luminance enhancement film. The diffractive luminance enhancement film produced from the resin composition in Comparative Example 2 was cracked upon release from the mold, thus making it impossible to conduct the following evaluation.

### <Evaluation>

### Fine Pattern Transferability

Each of the diffractive luminance enhancement films obtained as described above was evaluated by confirming its angular vertical angle under a metallographic microscope. The evaluation criteria are as follows. The results are shown in Table 1.

O: Excellent (vertical angle 45°)
Δ: Transfer insufficiency (vertical angle 40 to 44°)
x: Transfer failure

As shown in Table 1, it was confirmed that the vertical angle of each of the diffractive luminance enhancement films in Comparative Examples 3 to 6 was smaller than the vertical angle (45°) of the mold. The diffractive luminance enhancement film in Comparative Example 7 could not be evaluated because it could not be released from the mold.

Releasability from the Mold

The releasability of the diffractive luminance enhancement film from the mold was evaluated by confirming the state thereof upon release from the mold. The evaluation criteria are as follows. The results are shown in Table 1.

### O: Excellent

Δ: Slight sticking

### x: Sticking

As shown in Table 1, the sticking of the resin composition to the mold occurred in the diffractive luminance enhancement film in Comparative Example 4 where a trifunctional monomer was used without using the bifunctional monomer in the composition and in the diffractive luminance enhancement films in Comparative Examples 6 and 7 where the urethane oligomer was not used. In the diffractive luminance enhancement films in Examples 1 to 3, on the other hand, excellent releasability from the mold could be obtained without using a mold release agent.

### Adhesion to the Supporting Base Film

The adhesion of the resin composition to the supporting base film (PET film) was evaluated according to JIS K5400. That is, the patterned region consisting of the resin composition in each diffractive luminance enhancement film was provided by a cutter with longitudinal 11 flaws and transversal 11 flaws reaching the base film, thereby forming 100 cross cut squares at 2-mm intervals thereon. A cellophane tape (width 25 mm, manufactured by Nichiban Co., Ltd.) was closely pressed on the patterned region and then rapidly peeled off, and the number of squares remaining on the patterned region was counted to evaluate the adhesion of the resin composition to the film. The evaluation criteria are as follows. The results are shown in Table 1.

O: 90 or more out of 100 squares remained.
Δ: 60 or more out of 100 squares remained.
x: Less than 60 out of 100 squares remained.

As shown in Table 1, after cured the adhesion of the resin composition to the supporting base film was insufficient in the diffractive luminance enhancement films in Comparative Example 5 where the urethane oligomer 2 consisting of an inappropriate amount of the raw materials was contained in the composition and in the diffractive luminance enhancement film in Comparative Example 3 where a monofunctional monomer was used without using the bifunctional monomer. On the other hand, the diffractive luminance enhancement films in Examples 1 to 3 were excellent in adhesion to the base film.

TABLE 1

| | Example | | | Comparative Example | | | | | | |
|---|---|---|---|---|---|---|---|---|---|---|
| Compound | 1 | 2 | 3 | 1 | 2 | 3 | 4 | 5 | 6 | 7 |
| UA1 | 90 | 50 | 10 | 100 | 0 | 50 | 50 | | | |
| UA2 | | | | | | | | 50 | | |
| AA | | | | | | | | | 50 | |
| EA | | | | | | | | | | 50 |
| 4EG-A | 10 | 50 | 90 | 0 | 100 | | | 50 | 50 | 50 |
| L-A | | | | | | 50 | | | | |
| TMP-A | | | | | | | 50 | | | |
| Photoinitiator | 2 | 2 | 2 | 2 | 2 | 2 | 2 | 2 | | 2 |
| Fine pattern | ◯ | ◯ | ◯ | Hardly | Sample | Δ | Δ | Δ | Δ | X |
| transferability | | | | handled | was | | | | | |
| Releasability | ◯ | ◯ | ◯ | due to | cracked | ◯ | Δ | ◯ | Δ | X |
| from the mold | | | | high | | | | | | |
| Adhesion to the | ◯ | ◯ | ◯ | vis- | | Δ | ◯ | X | ◯ | ◯ |
| base | | | | cosity | | | | | | |

Every numerical value in the table is shown in gram.
Abbreviations:
UA1, UA2: Urethane oligomers 1, 2
AA: Acryl acrylate oligomer (Hitaloid 7885SS2* manufactured by Hitachi Chemical Co., Ltd.; this product was a solvent-type material and thus used after its solvent was removed with an evaporator)
EA: Epoxy acrylate oligomer (Hitaloid 7660-1* manufactured by Hitachi Chemical Co., Ltd.; this product was a solvent-type material and thus used after its solvent was removed with an evaporator)
4EG-A: Tetraethylene glycol diacrylate (bifunctional monomer manufactured by Kyoeisha Chemical Co., Ltd.)
L-A: Lauryl acrylate (monofunctional monomer manufactured by Kyoeisha Chemical Co., Ltd.)
TMP-A: Trimethylol propane triacrylate (trifunctional monomer manufactured by Kyoeisha Chemical Co., Ltd.)
Photoinitiator: 1-Hydroxycyclohexyl phenyl ketone (trade name: IRGACURE 184, manufactured by Ciba Specialty Chemicals)

From the foregoing, it can be seen that the diffractive luminance enhancement films produced using the resin compositions in Example 1 to 3 are excellent in all items of fine pattern transferability, releasability from the mold, and adhesion to the supporting base film.

### Examples 4 to 8 and Comparative Examples 8 to 9

### Production of a Multilayer Optical Member

The same mold as used in production of the diffractive luminance enhancement film was filled with each of resin compositions for “Patterned layer” having formulations shown in Table 2 below, and then a PET film (trade name: A4300, film thickness 75 μm, manufactured by Toyobo Co., Ltd.) serving as a supporting base film was superimposed thereon. The resin composition was spread and flattened with a roller running thereon, and then exposed to light thereby curing the resin composition for patterned layer (patterned layer of the resin composition). This light exposure was conducted with an integrated light exposure of 2,000 mJ/cm² with an ultrahigh pressure mercury lamp (USH-3502MA, illuminance 16 mW/cm², manufactured by Ushio, Inc.).

After curing, the cured resin composition integrated with the supporting base film was released from the mold, and the patterned surface of the cured resin composition was coated with each of resin compositions for “Embedded Layer” having formulations shown in Table 2 below, and the same PET film as described above was superimposed thereon. The resin composition for embedded layer was spread and flattened with a roller running thereon, and then exposed to light in the same manner as described above thereby curing the resin composition for embedded layer (patterned embedded layer of the resin composition), to give a multilayer optical member.

Each of the multilayer optical members obtained as described above was evaluated for its fine pattern transferability, releasability from the mold and adhesion to the base in the same manner as for the diffractive luminance enhancement film. Further, the stacking characters (bubble entrainment and surface flatness) of the resin-composition patterned layer and embedded layer were evaluated by visual observation. The evaluation criteria were as follows: O was given when both of bubble entrainment and surface flatness were not problematic; Δ was given when one of the two items was problematic; and x was given when the two items were problematic. The results are shown in Table 2.

TABLE 2

| | | Example | | | | |
|---|---|---|---|---|---|---|
| | Compound | 4 | 5 | 6 | 7 | 8 |
| Patterned | UA1 | 90 | 50 | 10 | 90 | 10 |
| Layer | UA2 | | | | | |
| | L-A | | | | | |
| | 4EG-A | 10 | 50 | 90 | 10 | 90 |
| | TMP-A | | | | | |
| | Initiator | 2 | 2 | 2 | 2 | 2 |
| Fine pattern | | ◯ | ◯ | ◯ | ◯ | ◯ |
| transferability | | | | | | |
| Releasability | | ◯ | ◯ | ◯ | ◯ | ◯ |
| from the mold | | | | | | |
| Adhesion to the base | | ◯ | ◯ | ◯ | ◯ | ◯ |
| Embedded | UA1 | 90 | 50 | 10 | 10 | 90 |
| Layer | UA2 | | | | | |
| | L-A | | | | | |
| | BP-4PA | 10 | 50 | 90 | 90 | 10 |
| | TMP-A | | | | | |
| | Initiator | 2 | 2 | 2 | 2 | 2 |

| | | | | | |
|---|---|---|---|---|---|
| Stacking Characters | ◯ | ◯ | ◯ | ◯ | ◯ |

Comparative Example

| | Compound | 8 | 9 |
|---|---|---|---|
| Patterned | UA1 | | 50 |
| Layer | UA2 | 50 | |
| | L-A | | 50 |
| | 4EG-A | 50 | |
| | TMP-A | | |
| | Initiator | 2 | 2 |

| | | |
|---|---|---|
| Fine pattern | Δ | Δ |
| transferability | | |
| Releasability | ◯ | ◯ |
| from the mold | | |
| Adhesion to the base | X | X |

| | | | |
|---|---|---|---|
| Embedded | UA1 | | 50 |
| Layer | UA2 | 50 | |
| | L-A | | |
| | BP-4PA | 50 | |
| | TMP-A | | 50 |
| | Initiator | 2 | 2 |

| | | |
|---|---|---|
| Stacking Characters | Δ with | X with bubble |
| | bubble | entrainment and |
| | entrainment | uneven surface |

Every numerical value in the table is shown in grams.
The abbreviations in the table are the same as in Table 1 provided that BP-4PA is bisphenol A propylene oxide-added diacrylate (bifunctional monomer manufactured by Kyoeisha Chemical Co., Ltd.)

From Table 2, it can be seen that the multilayer optical members in Examples 4 to 8 have a fine pattern formed as desired, do not undergo bubble entrainment upon formation of the patterned embedded layer, and have a flat embedded layer.

### Example 9

### Production of Wide View Film

The resin composition prepared in Example 2 was used to transfer and form a pattern on a PET film of 50 μm in thickness in the same manner as in Example 1, thereby producing a wide view film having the fine pattern shown in FIG. 12. The completed wide view film was mounted on a liquid crystal display, and when the display was observed in an oblique direction, the place of the display on which the film was not mounted indicated tone reversal, while the place on which the film was mounted was observed to be normal, thus indicating that the view angle was magnified.

### Example 10

### Nanoimprint

As shown in FIG. 9, the resin composition prepared in Example 3 was applied onto one side of a base 11 of 0.7 μm in thickness (alkali-free glass substrate) and then dried to form a resin layer 10 of 3 μm in thickness, and then a mold 17 made of Si (size 10 mm×10 mm) having a pattern in which holes of 0.2 μm in diameter and 1.4 μm in depth were arranged two-dimensionally at regular 1.4-μm intervals was pressed against the resin layer 10, and then the resin layer 10 was cured by exposing it via the base 11 to light under the same conditions as in Example 1, followed by releasing the mold, whereby a nanopillar pattern of 0.2 μm in diameter and 1.4 μm in depth could be formed by transfer onto the whole surface of the base.

1. A resin composition comprising:
a urethane oligomer (A) obtained by blending:
a diisocyanate compound having two isocyanate groups in a molecule,
a hydroxylated methylene glycol compound represented by the following general formula (I): 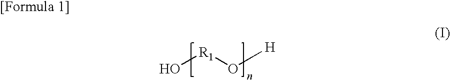
wherein R₁ is a linear or branched hydrocarbon group having 1 to 10 carbon atoms, and n is an integer of 1 to 20, and
a caprolactone-modified (meth)acrylate compound represented by the following general formula (II): 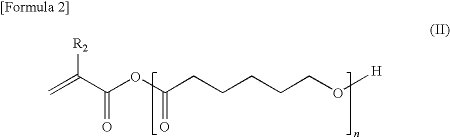
wherein R₂ is a hydrogen atom or a methyl group, and n is an integer of 1 to 10, such that the equivalent ratio between the isocyanate groups and the hydroxyl groups in the general formulae (I) and (II) (NCO/OH) is 0.8 to 1.2,
a bifunctional monomer (B), and
a polymerization initiator (C).

2. The resin composition according to claim 1, wherein the weight-average molecular weight (Mw) of the urethane oligomer (A) is 2,000 to 20,000.

3. The resin composition according to claim 1, wherein the compounding ratio of the urethane oligomer (A) to the bifunctional monomer (B) is in the range of from 1:9 to 9:1 by weight.

4. The resin composition according to claim 1, wherein the polymerization initiator (C) is contained in an amount of 0.01 to 5 parts by weight based on 100 parts by weight of the urethane oligomer (A) and the bifunctional monomer (B) in total.

5. The resin composition according to claim 1, wherein the bifunctional monomer (B) is one member or more selected from the group consisting of tetramethylene glycol diacrylate, dimethylol-tricyclodecane diacrylate, 1,9-nonanediol diacrylate, 1,6-hexanediol diacrylate, neopentyl glycol diacrylate, 2-butyl-2-ethyl-1,3-propanediol diacrylate, bisphenol A propylene oxide-added diacrylate, and caprolactone-modified tricyclodecane dimethanol diacrylate.

6. A multilayer optical member obtained by using the resin composition of claim 1.
